(19) United States
(12) Patent Application Publication
(10) Pub. No.: US 2020/0331121 A1
(43) Pub. Date: Oct. 22, 2020

(54) TOGGLE CLAMP DEVICE, IN PARTICULAR FOR USE IN VEHICLE BODY MANUFACTURING IN THE AUTOMOTIVE INDUSTRY

(71) Applicant: OLAF UND ANDRE TUNKERS GBR, Ratingen (DE)

(72) Inventor: Josef-Gerhard TÜNKERS, Ratingen (DE)

(73) Assignee: OLAF UND ANDRE TUNKERS GBR

(21) Appl. No.: 16/918,381

(22) Filed: Jul. 1, 2020

Related U.S. Application Data
(62) Division of application No. 15/558,748, filed on Jan. 19, 2018.

(30) Foreign Application Priority Data
Oct. 6, 2014 (DE) 10 2014 014 857.2
Jul. 3, 2015 (DE) 20 2015 004 786.6

(51) Int. Cl. B25B 5/12

(52) U.S. Cl. CPC B25B 5/122; B23K 37/0435

(57) ABSTRACT

A toggle clamp device, in particular for use in vehicle body manufacturing in the automotive industry. The worldwide industry standard for the range of toggle clamps in the automotive industry contains the same technical data for the structural dimensions, clamping and retaining forces and cylinder diameters. Deviating from this standard while maintaining the technical data, according to the invention, smaller cylinder diameters are used which lead to a reduction in compressed air or energy consumption of between 25 to 60%.

### CROSS-REFERENCE TO RELATED APPLICATIONS

This application is a divisional application of U.S. Ser. No. 15/558,748, filed Jan. 19, 2018, which is a U.S. national phase application filed under 35 U.S.C. § 371 of International Application No. PCT/EP2015/001832, filed Sep. 12, 2015, designating the United States, which claims benefit of the filing date of DE 10 2014 014 857.2, filed Oct. 6, 2014, and DE 20 2015 004 786.6, filed Jul. 3, 2015, which are incorporated herein by reference in their entirety.

### BACKGROUND OF THE INVENTION

The invention relates to a toggle clamp device, in particular for use in vehicle body manufacturing in the automotive industry.

A large number of different designs of toggle clamp devices are already known. The documents listed in the literature index show a selection. Toggle clamp devices of this type customarily consist of what is referred to as a clamping head on which a drive in the form of a piston-cylinder unit is arranged. The piston of said piston-cylinder unit is preferably acted upon alternately on both sides by compressed air in order, via a piston rod, to drive a toggle linkage mechanism arranged in the clamping head. Said toggle linkage mechanism is assigned a clamping arm which is driveable pivotably by a limited angular dimension about a pivot axis fixed in position in the clamping head. The clamping arm can differ in design. Large numbers of toggle clamp devices of this type are used in manufacturing systems, in particular in vehicle body manufacturing in the automotive industry, in order to keep sheet-shaped parts of a vehicle body in position so that they can be permanently connected to one another, for example by spot welding, by adhesive bonding or by clinching. The space for accommodating toggle clamp devices and other devices is often limited in said manufacturing systems. It has therefore already been proposed to design the cylinders of the piston-cylinder units to be flatly oval in order to save space. However, the cylinders then continue to still be relatively long since pistons of certain sizes are needed in order to obtain the required clamping forces. The attempt to use smaller cylinders has failed because the clamping heads then also have to be replaced in order to adapt them to the smaller piston-cylinder units, along with a reduction in the clamping forces.

A large number of toggle clamp devices of this type which are generally supplied with compressed air are installed in manufacturing systems of vehicle body manufacturing in the automotive industry. This necessitates a high energy consumption for supplying the compressed air which, after actuation of the toggle clamp device, flows unused into the free atmosphere from the toggle clamp devices, which frequently go into the thousands, of a single automotive plant. It has therefore already been considered how this energy consumption can be restricted and the environment protected. Among other things, electrically operated toggle clamp devices have been proposed, but they have up to now not nearly been as widespread as toggle clamp devices driven by compressed air. This can be attributed to the fact that the manufacturing plants predominantly have installed compressed air distribution systems. In addition, problems have initially been found in dissipating the heat caused by the encapsulated electric drive motors.

DE 10 2008 007 256 B3 has disclosed a working cylinder, in particular for use in vehicle body manufacturing in the automotive industry, for a pressurized fluid, with a cylinder and a piston which is guided in a longitudinally displaceable and sealing manner therein and is connected integrally to a piston rod which is led out of the cylinder in a sealed manner and, with the interconnection of transmission parts, such as links, parallelogram transmissions, toggle joint arrangement or the like, drives devices for clamping and/or joining and/or stamping and/or embossing and/or welding and/or punching and/or clinching, with at least one control valve designed as a multi-way valve, a pressure medium source and channels or lines, which connects the fluid source via the control valve either simultaneously to the mutually opposite cylinder chambers (piston-rod-side cylinder chamber and working cylinder chamber) or alternately to the piston-rod-side cylinder chamber during the opening stroke, or connects the pressure medium source to the working cylinder chamber only during the power stroke after the idle stroke has ended, wherein a further valve designed as a multi-way valve is arranged between the pressure medium source and the control valve, said further valve firstly controlling the connection to the pressure medium source during the idle stroke, the power stroke and the opening stroke of the piston and secondly controlling the removal of the residual amount from the piston-rod-side cylinder chamber when the power stroke is initiated, wherein the valves within the working cylinder together with the channels connecting them are arranged in a structurally unified manner. This device can be used particularly advantageously for driving toggle clamp devices, clinch devices and centering devices in vehicle body manufacturing in the automotive industry. Such devices driven by toggles are used there in large piece numbers on manufacturing lines, and therefore use is normally made of large quantities of compressed air that are basically not required at all during the idle stroke. By contrast, in the case of the working piston according to the invention, an extremely small quantity of compressed air is vented into the atmosphere if the need arises when the power stroke is initiated since the power stroke is acted upon with the full pressure medium pressure only a few millimeters before the end of the entire stroke of the piston that is used, for example, for driving a clamping arm of a toggle clamp device. Only said very small quantity of compressed air located on the piston rod side flows if the need arises into the atmosphere, said quantity of compressed air being, however, only a fraction of the quantity of the compressed air. In the case of the large piece numbers of such clamping devices which are used in vehicle body manufacturing in the automotive industry worldwide, but also only in a national economy of an industrial nation, when a working cylinder according to the invention is used there is a noticeable easing of the burden on the environment, particularly if an energy balance is set up over a certain period of time, for example over a year. A further control valve designed in particular as a multi-way valve is arranged between the fluid source and control valve. The valves are arranged within the working cylinder together with the channels connecting them in a structurally unified manner.

DE 10 2006 041 707 B4 has likewise disclosed a piston-cylinder unit (working cylinder), with a piston which is guided in a longitudinally displaceable and sealing manner in a cylinder by fluid pressure and which, on one side (piston ring side), is assigned a piston rod which is led in a sealing manner out of the cylinder and drives device parts for clamping and/or pressing and/or joining and/or stamping and/or embossing and/or punching and/or welding, for example with the interconnection of a toggle linkage arrangement, wherein the working cylinder is assigned channels which, from the beginning to the end of the idle stroke (setting stroke), permit a working cylinder chamber and also a cylinder return chamber to be acted upon with the fluid pressure and, at the beginning of the initiation of the power stroke, vent the cylinder return chamber and only act upon the working cylinder chamber with fluid pressure, wherein, on one side of the piston rod, the piston is assigned a control pin in a bore, the control pin being mounted against the restoring force of a pretensioned compression spring element and which, when the power stroke is initiated, actuates a valve or a piston valve in such a manner that the piston ring side has to be vented, or in such a manner that the piston return chamber is connected via a control system to the fluid supply line and/or removal line. In a further embodiment of this previous publication, the fluid supply during the idle stroke (setting stroke) of the piston is controlled in such a manner that only the inertia forces and/or weight forces and/or frictional forces of movable parts are overcome and, only during the power stroke, can the piston be acted upon with the fluid pressure, wherein, on one side of the piston rod, the piston is assigned a control pin in a bore, the control pin being mounted against the restoring force of a pretensioned compression spring element and which, when the power stroke is initiated, actuates a valve or a piston valve in such a manner that the piston ring side has to be vented. Furthermore, a fork head connected to the piston rod or a toggle linkage arrangement connected thereto can control a valve, for example a piston valve, at the end of the idle stroke (setting) in such a manner that the full fluid pressure now acts on the piston. By this means, the fluid consumption and in particular energy consumption for the pumps and the drive motor thereof, in particular the consumption of compressed air and hydraulic fluid, is intended to be considerably reduced, for example by 50%, as a result of which the energy costs for operating manufacturing systems in vehicle body manufacturing are intended to be able to be very considerably reduced.

The disclosed documents of German utility model 20 2009 008 068.4 have likewise disclosed a device for clamping and/or joining and/or stamping and/or embossing and/or welding and/or punching and/or clinching and/or pivoting, in particular for use in vehicle body manufacturing in the motor vehicle industry, in which the pressure medium, primarily compressed air, can be supplied from the fluid or pressure medium source, to the two cylinder chambers, i.e. both to the piston rod side and to the working cylinder, always only by a single pressure medium line. As a result, energy can be saved.

DE 20 2009 002 141 U1 has disclosed a device with an adjusting member which is movable in opposite directions by rectilinear stroke movements in the axial direction by means of a drive, is arranged in a housing and, via a toggle linkage arrangement arranged in a housing head, pivotably drives a lever in opposite directions by a limited angular dimension about an axis fixed on the housing head between a working position, in which the adjusting member enters the housing head to the maximum extent, and an opening position and which is exchangeably assigned, for example, one or more masses, in particular for use in vehicle body manufacturing in the automotive industry, wherein the adjusting member is pivotably connected via an adjusting-member coupling axis to a link arrangement of a toggle linkage, and the link arrangement in turn is pivotably connected via a link pivot axis to a connecting link arrangement and the latter, for its part, is pivotably connected to the axis fixed on the housing head, wherein, in the working position, the link pivot axis is pivoted in the spacing next to the axis fixed to the housing head at maximum into the outer end region of the housing head interior and the toggle linkage arrangement, for its part, in the dead center position or position beyond the dead center, extends its rectilinear connecting line, which runs through the rotation center points of the adjusting-member coupling axis, on the one hand, and of the link pivot axis, on the other hand, at right angles or virtually at right angles to the stroke longitudinal axis of the adjusting member, wherein the entire pivoting angular range about which the lever is pivotable about the axis fixed to the housing head is offset by an acute angle in relation to the center line of the adjusting member in the plane of pivoting of the arm about the pivoting center point of the axis fixed to the housing head in the working position of the arm. Furthermore, this previously known device is characterized in that, in the working position of the arm, the imaginary rectilinear line running through the pivoting center points of the arm axis fixed to the housing head and of the adjacent link pivot axis forms an acute angle with an imaginary rectilinear line which runs through the pivoting center points of said link pivot axis and of the pivoting center point of the adjusting-member coupling axis, wherein said imaginary rectilinear line forms a right angle or approximately a right angle with the stroke longitudinal axis of the adjusting member in the working position, in particular in the dead center position or position beyond the dead center of the toggle linkage arrangement. This device is intended to make it possible in pivoting units to obtain a constant or virtually constant torque over the entire pivoting angular range of the arm via its pivot axis fixed to the housing head. Said angular range can be, for example, at maximum 185 degrees to 180 degrees. Owing to the fact that the entire angular range about which the lever can be pivoted about its axis fixed to the housing head via the toggle linkage is tilted or shifted forward by an acute angle away from the longitudinal axis of the adjusting member, the lever arm on which the forces can act via the adjusting member is favorably changed.

DE 10 2006 022 950 A1 likewise relates to a clamping device for securing workpieces, consisting of an adjusting mechanism which is connected to an axially adjustable adjusting rod of a pneumatically or hydraulically actuable driving member, the adjusting mechanism being formed from the end of the adjusting rod and from a dragging member which is connected in an articulated manner to an adjusting lever for the pivot shaft, which is mounted in a head piece, of the device clamping arm, wherein the housing of the driving member together with the adjusting rod piston thereof is extended at least by the stroke travel of the adjusting rod and a partition through which the correspondingly extended adjusting rod reaches and which bounds the stroke chamber of the driving member is arranged in the housing, wherein the cross section of the single-part housing corresponds via the partition to the stroke chamber, and that the internal height of the head piece is substantially dimensioned to the length of the adjusting lever. The housing of the driving member is extended by its adjusting rod piston at least by the stroke travel of the adjusting rod, wherein a partition through which the correspondingly extended adjusting rod reaches and which bounds the stroke chamber of the driving member is arranged in the housing. The cross section of the housing via the partition, i.e. toward the head piece to be placed thereon, corresponds here to the cross section of the stroke chamber. The internal height of the head piece which is to be placed on and fastened in a suitable manner is furthermore here substantially dimensioned to the length of the adjusting lever, i.e. the size or length of the head piece is substantially reduced in comparison to previous head pieces. The housing which therefore includes the actual driving member is provided here at the lower end with a correspondingly adapted closure plate and is an extending component. By this means, structurally extremely differently designed head pieces can be attached to the housing without having to change the single-part housing, if particular applications require this. This should be undertaken under the condition that such different head pieces have, however, to be adapted in terms of connection to the single-part housing.

### Problem

The invention is based on the problem of, in the case of a toggle clamp device provided according to the generic type, reducing the energy requirement by simple structural measures.

### Solution

The problem on which the invention is based is solved by each of the two independent patent claims 1 and 2.

Patent claim 1 describes a toggle clamp device, in particular for use in vehicle body manufacturing in the automotive industry, with connection dimensions determined according to standard specifications in the industry, for example for bores with a thread on the clamping head, for arranging the toggle clamp device on an assembly line, with a drive unit which is to be acted upon by compressed air and the piston of which is to be alternately acted upon by compressed air in opposite stroke directions and is guided in a longitudinally displaceable and sealing manner in a cylinder which is circular or deviates from the circular shape, for example is flatly oval, according to standards predetermined by the industry or designations, for example 40, 50, 63, wherein the piston drives a length-variable adjusting member in the stroke direction, which, at its piston-remote end, drives, via a toggle linkage mechanism, a force transmission arm which is connected in terms of drive and mounted via a rotary pin, which is pivotable in the clamping head but is otherwise immovable in position and which is led out of the clamping head on one side or on both sides, and which force transmission arm drives a clamping arm or the like pivotably, for example over a pivoting angle of 135 degrees, wherein, while maintaining the torque or the holding torque at the rotary pin and while maintaining the connection dimensions of the clamping head, the clamping head is in each case assigned a cylinder which is smaller in diameter within the industry standard 40, 50, 63 predetermined by the industry, and therefore a smaller pressure-effective piston and therefore a smaller force to be transmitted to the adjusting member, for example the piston rod, and the thereby in each case reduced piston force and the thereby reduced torque or holding torque at the rotary pin is restored to the original or virtually original value of the piston-cylinder unit which is larger within the industry standard by a corresponding increase in the effective lever length of the force transmission arm corresponding to the reduction of the piston force of the piston.

Independent patent claim 2 describes a solution for a toggle clamp device, in particular for use in vehicle body manufacturing in the automotive industry, in particular for use in vehicle body manufacturing in the automotive industry, with a clamping head, a piston-cylinder unit which is arranged thereon, is to be alternately acted upon by compressed air and drives an optionally length-variable adjusting member which extends in the stroke direction of the piston and, at its piston-remote end, via a toggle linkage mechanism and via a force transmission arm which pivotably drives a clamping arm or the like via a rotary pin which is immovable in position in the clamping head and is led out of the clamping head laterally, characterized in that, while maintaining the clamping force on the clamping arm and while maintaining the attachment dimensions of the clamping head, the clamping head is in each case assigned a cylinder which is smaller in diameter with a correspondingly smaller piston and therefore a smaller force to be transmitted to the adjusting member, for example the piston rod, and the thereby in each case reduced piston force is restored to the original value of a larger piston-cylinder unit by an increase in the effective lever length of the force transmission arm of the toggle linkage mechanism corresponding to the reduction of the piston force of the piston.

### Some Advantages

The worldwide industry standard for the range of toggle clamps in the automotive industry contains the same technical data for the structural dimensions, clamping and retaining forces and cylinder diameters. In a deviation from said standard, while maintaining the technical data, according to the invention smaller cylinder diameters are in each case used, leading to a reduction in compressed air or energy consumption of between 25 and 60%.

The toggle clamp device according to the invention is therefore distinguished in that, when a smaller cylinder with a smaller diameter and therefore smaller piston is used, the thereby reduced clamping force is compensated for by a greater torque of the toggle linkage mechanism. This takes place by the effective lever length of the force transmission arm being increased, specifically in each case depending on the clamping head, which otherwise remains identical, with attachment dimensions, which remain identical, for an otherwise larger piston-cylinder unit. By means of the increase in the effective lever length of the force transmission arm which drives the clamping arm, the reduced force exerted by the piston of the substantially smaller piston-cylinder unit is compensated for, while the dimensions are the same.

If the need arises, the simple replacement of the force transmission arm suffices in order to use a smaller cylinder while maintaining the clamping force at the clamping arm. It is therefore possible to use substantially smaller piston-cylinder units and thereby to considerably reduce the volume of said piston-cylinder units and therefore of the entire toggle clamp device. In association with the reduction in the dimensions of the entire toggle clamp device by means of smaller cylinder units, compressed air of between 25 and 60%, preferably approximately 38 or 40%, is spared since the cylinders which are smaller in diameter also require a smaller quantity of compressed air, which has an environmentally protective and therefore energy-saving effect. The invention therefore proposes a solution approach deviating from the prior art for reducing the energy consumption and protecting the environment.

For the measurement of the torque or of the holding torque, the starting point should be the same reference value. For example, the applicant measures the holding torque with an angle of 7 degrees, on the basis of the dead center position of the toggle linkage mechanism, in which the one tab takes up an angle of 90 degrees with respect to the longitudinal axis of the adjusting member, that is to say the piston rod. Over the course of the operating period, the holding torque or torque at the rotary pin changes due to wear phenomena. If different competing products are therefore compared with one another in respect of the holding torques or torques at the rotary pins, the starting point has to be the same initial conditions for the measurement. However, this does not alter the fact that, even in the case of different measuring methods, the determination of the torque or holding torque of the rotary pin significant energy savings are retained by the solution proposals according to the invention because use can now be made of smaller cylinders without changing the clamping head and without changing the attachment dimensions thereof. When cylinders are discussed, they are understood as meaning not only cross-sectionally circular cylinders, and therefore also pistons with effective piston surfaces of a circle, but also cylinders which have a shape of the pistons and therefore of the internal cross sections of the cylinders that differs from the circular shape and in which the pistons slide sealed and alternately acted upon by compressed air. Cylinders deviating from the circular shape are preferably understood as meaning those which have a flatly oval design. Where effective piston surfaces are referred to here in the case of pistons deviating from the circular shape, this involves pressure-effective surfaces.

### FURTHER INVENTIVE REFINEMENTS

Further inventive refinements are described in patent claims 3 to 9 and, furthermore, further features and advantages emerge from the attached description of the drawing, in which the invention is illustrated, partially schematically, by way of example. In the drawing:

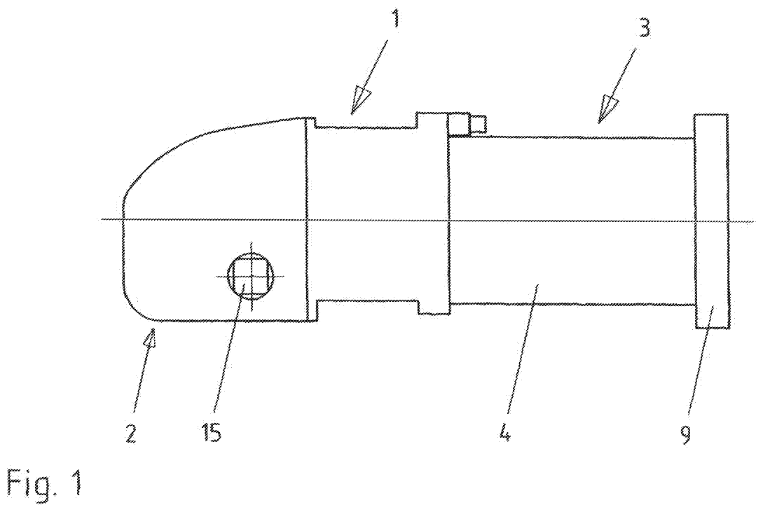

FIG. 1 shows a toggle clamp device schematically in side view,

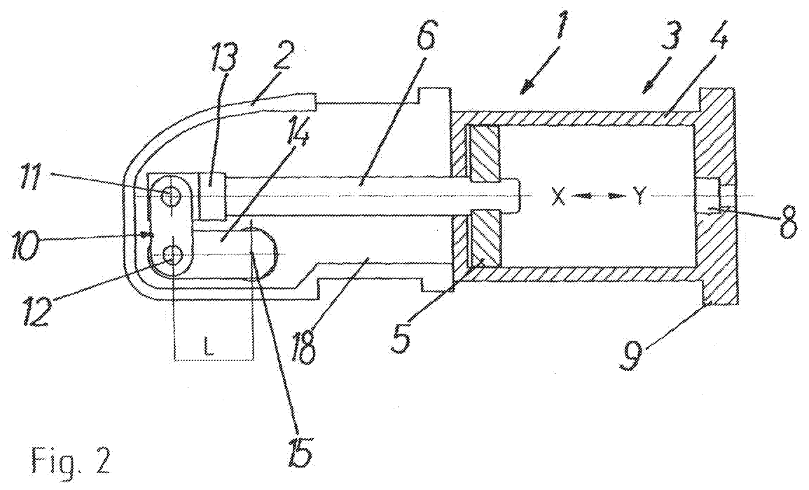

FIG. 2 shows a longitudinal section through a toggle clamp device according to FIG. 1, and

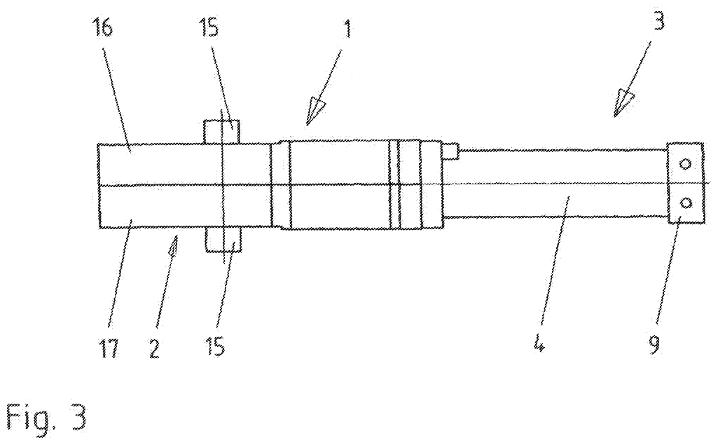

FIG. 3 shows a top view of FIG. 2.

In the drawing, reference sign 1 overall denotes a toggle clamp device which essentially consists of a clamping head 2 and a piston-cylinder unit 3 arranged interchangeably on the latter. If the need arises, the toggle clamp device is provided on all four sides of the clamping head 2 with blind bores with a thread in order to be able to optionally attach said toggle clamp device at all four side surfaces.

The piston-cylinder unit 3 has a cylinder 4 and a piston 5 which is guided in a longitudinally displaceable and sealing manner therein. The piston 5 is alternately acted upon on both sides in a controlled manner by compressed air, and thereby carries out a stroke in the X or Y direction.

An elongate adjustment member, which is designed as a piston rod 6, is connected in terms of drive to the piston 5, said adjustment member, in the embodiment illustrated, but not necessarily, being of multi-part and length-adjustable design in order to permit a length adjustment in the X or Y stroke direction and the stroke in the X or Y direction of the piston 5 and thereby to change to the pivoting angle of a clamping arm or the like. For this purpose, the piston rod can consist of multi-part spindle parts which are screwable into one another.

For the length adjustment of the piston rod 6, it is possible to reach through a closable opening 8 into a bottom cover 9 of the cylinder 4 with a tool in order to connect said tool if the need arises to a recess in a screw head 7 of the piston rod 6. The piston rod 6 can then be rotated in opposite directions by means of the tool and, as a result, the stroke of the piston 5 in the X or Y direction can be infinitely variably adjusted to be greater or smaller. The sensitivity of the adjustment conforms to the pitch of the thread, at which the parts of the elongate adjustment member 6 are screwed into one another.

A toggle linkage mechanism 10 which consists of a plurality of tab elements coupled pivotably to one another via pivot axes 11 or 12 is connected in terms of drive to the piston rod 6. Said tab elements can be connected in terms of drive to the piston rod 6 or to part of the piston rod 6, for example via a fork head 13, and to one another in terms of drive and interchangeably.

A force transmission arm 14 is connected in terms of drive and pivotably to the toggle linkage mechanism 10. The force transmission arm 14 can consist of a plurality of elements. The force transmission arm 14 is connected in terms of drive via a rotary pin 15 which is indicated in FIG. 2 merely by a chain-dotted cross-hair pointer, is pivotable in the clamping head 2, but is otherwise immovable in position and is led out of the clamping head 2 laterally (FIG. 3) and here, in the embodiment illustrated (FIG. 1), has a square shape to which a clamping arm (not illustrated) can be releasably coupled, for example in the form of a fork or else only on one side. The clamping arm can be used to clamp sheet-like workpieces against a suitable abutment, for example what is referred to as a jaw (not illustrated), which is assigned to the clamping head 2, in order then to be able to permanently connect the workpieces to one another in a suitable manner, for example by clinching, spot welding or adhesive bonding.

The center point of the pivot axis 12, on the one hand, and of the rotary pin 15 which is immovable in position, on the other hand, are remote from each other by the dimension L (FIG. 2) which forms the effective lever arm with which the toggle linkage mechanism 10 drives the clamping arm (not illustrated) or the like. Said effective lever arm L is enlarged in comparison to conventional toggle clamp devices in such a manner that the relatively small piston-cylinder unit 3, which has a correspondingly small piston 5, is compensated for in terms of its reduced force, with which it drives the piston rod 6, in such a manner that, while the connection dimensions remain identical and the clamping head remains identical, the correspondingly large clamping force (torque) which would be achieved in the case of an otherwise larger piston-cylinder unit 3 is likewise obtained. It is thereby possible, with the same connection dimensions and an identical clamping head, to connect a substantially smaller piston-cylinder unit 3 which therefore considerably reduces the volume of the entire toggle clamp device and causes a substantially lower consumption of compressed air, for example by at least 25 to 60%, preferably, for example in the embodiment illustrated, 38% less than in the case of conventional toggle clamp devices of identical power. It is thereby possible to keep ready, as it were, identical clamping heads for the same connection dimensions on the bearing, to which clamping heads different piston-cylinder units 3 having considerably smaller diameters can be coupled if the need arises. The smaller clamping force is compensated for by the larger lever arm L in the illustrated embodiment. For example, the illustrated embodiment shows a toggle clamp device having the designation U 63, which is, however, only assigned a 50 cylinder.

The dimension “50” designates the effective piston diameter and therefore also the inside diameter of the cylinder 4. For example, the dimension L for a U 63 clamp with a 50 cylinder can be 42 mm while the overall stroke of the piston 5 is 103 mm at a maximum pivoting angle of the clamping arm (not illustrated) of 135°.

In the case of the illustrated embodiment, the clamping head 2 consists of two housing parts which are arranged on each other in the manner of a sandwich, preferably housing halves 16 and 17, which are arranged on each other in a sealed manner and sealingly surround an interior space 18 of the clamping head 2 and thereby substantially protect the toggle linkage mechanism 10 and also those parts of the piston rod 6 screwable into one another that are arranged here against dirt and moisture.

Sensors (not illustrated) which are damped by a switching tag and thereby in each case detect the end positions of the piston rod 6 can be provided in the clamping head 2. The measurement values are transmitted to a plug unit, from which the data are tapped off and forwarded to a suitable central control unit (likewise not illustrated).

The features which are described in the patent claims and in the description and are also apparent from the drawing may be essential both individually and in any combination for realizing the invention.

### REFERENCE SIGNS

1 Toggle clamp device

2 Clamping head

3 Piston-cylinder unit

4 Cylinder

5 Piston

6 Piston rod, elongate adjusting member

7 Screw head

8 Opening

9 Bottom cover

10 Toggle linkage mechanism

11 Pivot axis

12 ″

13 Fork head

14 Force transmission arm

15 Rotary pin

16 Housing part

17 ″

18 Interior space of the clamping head 2

X Stroke direction

Y ″

L Effective lever length of the force transmission arm 14

### LITERATURE INDEX

DE 11 2010 005 923

DE 10 2006 041 707 A1

DE 10 2006 022 950 A1

DE 10 2004 007 346 B3

DE 10 2004 027 849 A1

DE 10 2004 034 280 A1

DE 10 2007 027 849 A1

DE 10 2008 007 256 B3

DE 698 10 413 T3

DE 198 24 579 C1

DE 199 30 990 C1

DE 196 16 441 C1

DE 195 12 429 A1

DE 101 36 057 C1

DE 102 60 138 A1

DE 18 16 402 A1

DE 19 41 785 A1

DE 36 01 643 A1

DE 36 38 526 C1

DE 42 42 601 A1

DE 333 903 C

DE 202 07 776 U1

DE 297 00 887 U1

DE 298 11 331 U1

DE 20 2007 017 274.5

DE 20 2009 008 068 U1

DE 20 2009 002 141 U1

EP 2 329 153

EP 2 055 430 B1

EP 1 262 285 A2

EP 1 849 559 B1

EP 1 878 539 B1

EP 1 309 426 B1

EP 1 088 623 A2

EP 1 179 394 A

EP 1 149 665 A

EP 1 066 929 A

EP 0 908 272 B1

EP 0 967 050 A2

EP 0 243 599 A

WO 2005/044517 A2

WO 2007/128437 A1

WO 2010/127690 A1

WO 2012/045320 A1

U.S. Pat. No. 4,793,602

U.S. Pat. No. 6,065,743

U.S. Pat. No. 6,612,557

U.S. Pat. No. 6,220,588

U.S. Pat. No. 6,613,133

U.S. Pat. No. 6,416,045

Tünkers Maschinenbau GmbH, Ratingen, prospectus “Spanntechnik für professionelle Serienfertigung”

Tünkers Maschinenbau GmbH, Ratingen, prospectus “Produktionsprogramm”

Tünkers Maschinenbau GmbH, Ratingen, prospectus “Spannsysteme, Handling, Umformtechnik”

Mannesmann Rexroth: “Grundlagen und Komponenten der Fluidtechnik Hydraulik Der Hydraulik Trainer”, October 1991 (1991-10), ISBN: 3-8023-0619-8, vol. 1, pages 182-183

1. A toggle clamp device for use in vehicle body manufacturing in the automotive industry, with connection dimensions determined according to standard specifications in the industry, for bores with a thread on the clamping head, for arranging the toggle clamp device on an assembly line, with a drive unit which is to be acted upon by compressed air, and a piston of which is to be alternately acted upon by compressed air in opposite stroke directions and is guided in a longitudinally displaceable and sealing manner in a cylinder which is circular or deviates from the circular shape, the cylinder and piston having effective cylinder and piston diameters, wherein the piston drives a member in the stroke direction (X-Y), which, at its piston-remote end, drives, via a toggle linkage mechanism, a force transmission arm which is connected in terms of drive and mounted via a rotary pin, which is pivotable in the clamping head but is otherwise immovable in position and which is led out of the clamping head on one side or on both sides, and which force transmission arm drives a clamping arm pivotably, wherein, while maintaining the substantially the same torque or holding torque at the rotary pin and while maintaining the connection dimensions of the clamping head for an effective cylinder and piston diameter designation predetermined by the automotive industry, the cylinder has an effective diameter smaller than the predetermined effective cylinder and piston diameter designation predetermined by the automotive industry, and the force transmission arm has a larger effective lever length (L) to compensate for reduction of the piston force of the piston of smaller effective diameter.

2. The toggle clamp device as claimed in claim 1, wherein a toggle clamp device designated with the industry designation 63 (cylinder ∅ 63 mm) has a cylinder having an effective cylinder diameter ∅ of 50 mm.

3. The toggle clamp device as claimed in claim 1, wherein a toggle clamp device designated with the industry designation 50 (cylinder ∅ 50 mm) has a cylinder having cylinder diameter ∅ of 40 mm.

4. The toggle clamp device as claimed in claim 1, wherein a toggle clamp device designated with the cylinder designation U-63 (cylinder ∅ 63 mm) has a cylinder with an effective piston diameter of 50 mm, an effective lever dimension (L) of the force transmission arm of 42 mm, an overall stroke of the piston of 103 mm and a pivoting angle of at maximum 135 degrees.

5. The toggle clamp device as claimed in claim 1, wherein the energy consumption of the compressed air or the compressed air consumption of the toggle clamp device is lowered from a toggle clamp device having an effective cylinder and piston diameter corresponding to the predetermined effective cylinder and piston diameter designation by at least 25%.

6. The toggle clamp device as claimed in claim 1, wherein the member is a length-variable piston rod.

7. A toggle clamp device for use in vehicle body manufacturing in the automotive industry, with a clamping head, a piston-cylinder unit which is arranged thereon, is to be alternately acted upon by compressed air and drives an optionally length-variable adjusting member which extends in the stroke direction (X-Y) of the piston and, at its piston-remote end, via a toggle linkage mechanism and via a force transmission arm which pivotably drives a clamping arm via a rotary pin which is immovable in position in the clamping head and is led out of the clamping head laterally, characterized in that, while maintaining the clamping force on the clamping arm and while maintaining the attachment dimensions of the clamping head, the clamping head is in each case assigned a cylinder which is smaller in diameter with a correspondingly smaller piston and therefore a smaller force to be transmitted to the adjusting member, and the thereby in each case reduced piston force is restored to the original value of a larger piston-cylinder unit by an increase in the effective lever length (L) of the force transmission arm of the toggle linkage mechanism corresponding to the reduction of the piston force of the piston.

8. The toggle clamp device as claimed in claim 7, wherein a toggle clamp device designated with the industry designation 63 (cylinder ∅ 63 mm) has a cylinder having an effective cylinder diameter ∅ 50 mm).

9. The toggle clamp device as claimed in claim 7, wherein a toggle clamp device designated with the industry designation 50 (cylinder ∅ 50 mm) has a cylinder having an effective cylinder diameter ∅ of 40 mm).

10. The toggle clamp device as claimed in claim 7, wherein a toggle clamp device designated with the cylinder designation U-63 (cylinder ∅ 63 mm) has a cylinder with an effective piston diameter of 50 mm, an effective lever dimension (L) of the force transmission arm of 42 mm, an overall stroke of the piston of 103 mm and a pivoting angle of at maximum 135 degrees.

11. The toggle clamp device as claimed in claim 7, wherein the energy consumption of the compressed air or the compressed air consumption of the toggle clamp device is lowered from a toggle clamp device having an effective cylinder diameter corresponding to the predetermined effective cylinder and piston diameter designation by at least 25%.

12. The toggle clamp device as claimed in claim 7, wherein the member is a length-variable piston rod.

13. A method for optimizing an existing toggle clamp device for use in vehicle body manufacturing in the automotive industry, with connection dimensions determined according to standard specifications in the industry, the toggle clamp device comprising a drive unit which is to be acted upon by compressed air, and a piston of which is to be alternately acted upon by compressed air in opposite stroke directions and is guided in a longitudinally displaceable and sealing manner in a cylinder which is circular or deviates from the circular shape, the cylinder and piston having effective cylinder and piston diameters, wherein the piston drives a member in the stroke direction (X-Y), which, at its piston-remote end, drives, via a toggle linkage mechanism, a force transmission arm which is connected in terms of drive and mounted via a rotary pin, which is pivotable in the clamping head but is otherwise immovable in position and which is led out of the clamping head on one side or on both sides, and which force transmission arm drives a clamping arm pivotably, the method comprising substituting the cylinder and piston with a cylinder and piston having an effective diameter smaller than the predetermined effective cylinder and piston diameter designation predetermined by the automotive industry, and substituting the force transmission arm with a force transmission arm having a larger effective lever length (L) to compensate for reduction of the piston force of the piston of smaller effective diameter while maintaining the substantially the same torque or holding torque at the rotary pin and while maintaining the connection dimensions of the clamping head for an effective cylinder and piston diameter designation predetermined by the automotive industry.

14. The method according to claim 13, wherein the toggle clamp device further comprises a housing having an interior space within which are provided, the piston-remote end of the member, the toggle linkage mechanism, the force transmission arm, and a portion of the rotary pin, wherein the force transmission arm is provided adjacent the piston-remote end of the member within the interior space of the housing.

15. The toggle clamp device of claim 7, further comprising a housing having an interior space within which are provided, the piston-remote end of the member, the toggle linkage mechanism, the force transmission arm, and a portion of the rotary pin, wherein the force transmission arm is provided adjacent the piston-remote end of the member within the interior space of the housing.

16. The toggle clamp device of claim 1, further comprising a housing having an interior space within which are provided, the piston-remote end of the member, the toggle linkage mechanism, the force transmission arm, and a portion of the rotary pin, wherein the force transmission arm is provided adjacent the piston-remote end of the member within the interior space of the housing.
